(19) United States
(12) Patent Application Publication
(10) Pub. No.: US 2022/0109995 A1
(43) Pub. Date: Apr. 7, 2022

(54) GENERATION AND IMPLEMENTATION OF DISTINCTIVE EVENT BASED CRYPTOGRAPHIC TOKEN VIA MACHINE RECOGNIZED EVENT

(71) Applicant: John Vermes, Palo Alto, CA (US)

(72) Inventor: John Vermes, Palo Alto, CA (US)

(21) Appl. No.: 17/063,124

(22) Filed: Oct. 5, 2020

(51) Int. Cl. H04W 12/30; H04L 9/32; H04L 9/06; H04W 12/06; G06N 20/00; H04Q 9/00; G06K 9/00

(52) U.S. Cl. CPC H04W 12/30; H04L 9/3234; H04L 9/0643; H04W 12/06; G06K 2009/00738; H04Q 9/00; G06K 9/00711; H04Q 2209/40; G06K 2209/03; G06N 20/00

(57) ABSTRACT

Described herein are novel uses of sensor fusion related to cryptographic implementations. A sensor platform is employed to generate a cryptographic token that is representative of the “biometrics” of a moment in spacetime. The cryptographic tokens are purposefully (as opposed to random) generated keys/passwords or data scrambling elements. A given computer resource is tied to a detected ground truth event, and then the cryptographic token is employed as a manner to connect a user to that computer resource.

### TECHNICAL FIELD

The present disclosure is directed to perceptrons and cryptography. More specifically generation and implementation of keys/passwords/key components as related to machine recognized events.

### BACKGROUND

In the modern world, communications are passed between parties in a variety of different ways utilizing many different communications media. Electronic communication is an efficient manner of transferring information.

Cryptography and security involve the encrypting or encoding of a resource, followed by the decryption or decoding of a received or retrieved resource. Other relevant embodiments involve resources that are positioned in public but require a key or password to access. The contents therein may not be encrypted but are otherwise inaccessible without the necessary password/key.

Known password/key generation schemes involve human generated passwords, randomly generated passwords, mathematically generated passwords, and biometric passwords.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for generation of cryptographic tokens via a single device.

FIG. 5 is a flow diagram illustrating a process used in some implementations for generation of cryptographic tokens coordinated across multiple devices.

FIG. 6 is a flow diagram illustrating a process used in some implementations for machine recognition of events.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to event driven cryptographic passwords, keys, or key stretching “salts”/“peppers” (collectively “cryptographic tokens”). Based on the granularity of a given sensor or sensor platform, any given detected moment in time or event that happens is unique, or at least highly distinctive. For example, a sensor platform simultaneously detects:

movement at a given vector;

an audio recording from inside a user's pocket including a combination of a bird chirping while a child wails about ice cream;

an image of the inside of the pocket crinkled in a current configuration;

a given processor temperature;

a given Global Positioning System (GPS) region; and

a given timestamp.

An isolated reading or combination thereof of the above detections distinctively describes an experienced event. The results of that detected event can be employed to generate a cryptographic token. In a colloquial sense, the cryptographic token is representative of the “biometrics” of a moment in spacetime. Where a given person may be identified based on sensor readings about them (e.g., iris scan, fingerprint scan, voice recognition, etc.) a moment of spacetime may be similarly identified.

The term cryptographic token illustrates the myriad potential ways that the detected event may be employed cryptographically. The results of the sensor platform may be employed directly as a password or key. The results of the sensor platform may be morphed in some manner that results in a password or key. The results of the sensor platform may be used as a salt value to complicate a password or key.

In some embodiments, the sensor platform is triggered to generate the cryptographic token based on machine recognition of a particular event. For example, through use of machine learning models or heuristics, the sensor platform identifies an object as having been thrown. Whereas a human may easily observe the act of throwing an object, machine recognition involves disambiguating between accelerometer readings that identify the action of throwing as opposed to jostling or dropping an object. In these embodiments, the sensor platform initiates collection of data to seed the cryptographic token in response to a positive event identification.

In some embodiments, the cryptographic token is used to access a storage resource, address space, or communications resource. The resource accessed may be linked to an event that triggered data collection that seeds the cryptographic token. Such embodiments may make use of a cryptographic token pair. A first token serves as a public identifier whereas the second token serves as an element used to access the resource identified by the public identifier.

In some embodiments, multiple sensor platforms work in concert to define and individually access the resource. In an illustrative example, two sensor platforms ride in cars that are in a collision. A coarse sensor located on each sensor platform independently identifies that each had been in a car crash (e.g., though, for example, exceeding a threshold deceleration). The term “coarse” is used in a relative sense—that is, the fidelity/precision of the coarse sensor is lower than the fidelity of a granular sensor (e.g., detection of presence at an address as opposed to detection of presence at GPS coordinates within 1 foot). The precision used by the coarse sensor is such that is it readily feasible that multiple devices may come to the same conclusion at the same time.

From the identification of a crash occurring in a same general vicinity at roughly the same time, the sensor platforms arrive either independently or in communication at a shared token that is used to identify a resource (e.g., such as a web storage space to collectively place documents and evidence concerning the car crash).

A granular sensor located on each sensor platform simultaneously records the specific readings and distinctive experience of the respective sensor platform during the crash. Each car in the crash will experience the crash differently. The experience may be significantly more violent for one than the other. If one car “t-boned” the other, one will experience a serious deceleration in the primary direction of momentum, whereas the other will experience significant acceleration in a direction perpendicular to the direction of momentum. Each of these sensor readings is representative to the distinctive physical circumstances experienced by the sensor platform. Each respective granular sensor generates asymmetric private tokens from sensor output. The asymmetric private tokens are used by each respective party to the crash to access the resource identified by the shared token (e.g., the asymmetric tokens are used for access to the shared token identified storage space).

The granular sensor creates a cryptographic token that is distinctly not random but cannot be reproduced because the readings detected by the granular sensor are at a level of specificity that cannot be feasibly repeated. In some embodiments, the coarse sensor(s) and granular sensor(s) are the same sensor, merely recording readings at varying degrees of fidelity/specificity.

The cryptographic token advances the technology of cryptography and security via the use of purposeful cryptographic variants that cannot be recreated.

### Terminology

A “cryptographic salt” or “salt” is scrambling data (e.g., the scrambling data is traditionally random but is described herein as purposeful) and is used as an additional input to a one-way function that hashes data, a password, or passphrase. Salts are additionally used in password stretching. For example, a weak password (e.g., “admin12345”) may be “stretched” into a stronger password by hashing the weak password with a salt. Salts are also used to safeguard passwords in storage. Historically, a password was stored in plaintext on a system, but over time additional safeguards were developed to protect a user's password against being read from the system. A salt is one of those methods. Cryptographic peppers are a variant on salts that are kept secret.

A “computer resource” collectively refers to identifiable digital objects, files, applications, or storage space on a system that a user wants to protect or restrict access to.

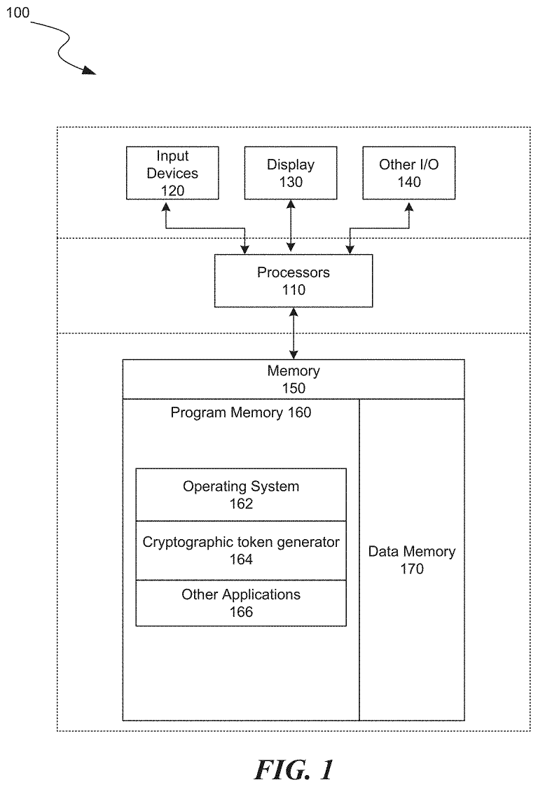

Several implementations are discussed below in more detail in reference to the figures. FIG. 1 is a block diagram illustrating an overview of devices on which some implementations of the disclosed technology can operate. The devices can comprise hardware components of a device 100 that includes a sensor platform. Device 100 can include one or more input devices 120 that provide input to the processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, a GPS sensor, a barometer, a thermometer, an accelerometer, an inertial motion unit (IMU), or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage and can include both read-only and writable memory. For example, a memory can comprise random-access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, a cryptographic token generator 164, and other application programs 166. Memory 150 can also include data memory 170, for example, sensor platform data, cryptographic token data, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

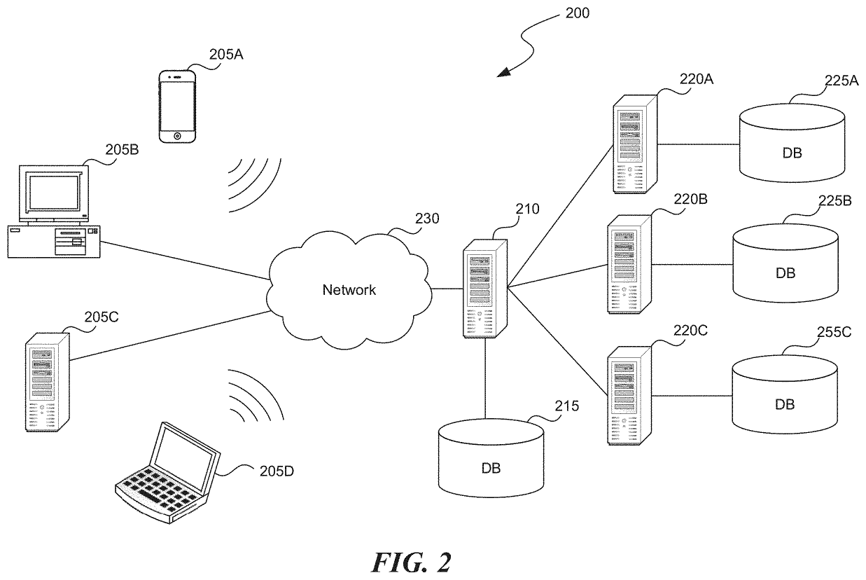

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as computer resources included in shared space data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN) but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

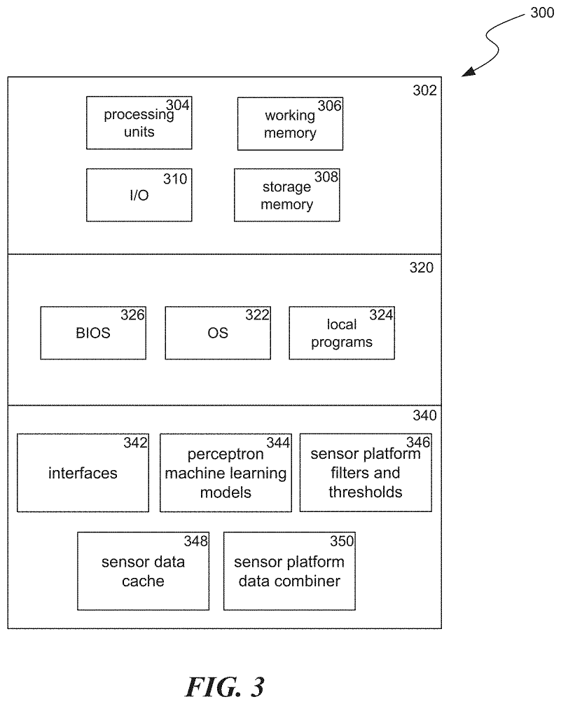

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g., CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include perceptron machine learning models 344, sensor platform filters and thresholds 346, a sensor data cache 348, a sensor platform data combiner 350, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

The perceptron machine learning models 344 are trained models that interpret sets of sensor data as ground truth events. A perceptron is a computer model or computing means running a computer model prepared to represent or simulate the ability of a human to recognize, distinguish, or classify. A percept in the case of a perceptron is the output of a recognition, distinguishing, or classification stage of the perceptron in response to an instance of data on which the perceptron has been prepared to act. In the typical case, the data in question is a numerical time series or ensemble of time series from a single sensor or a plurality of sensors, respectively. In the plural case, the ensemble of time series may be related to sensors affixed to a single sensor platform or, in an alternative case, to a plurality of sensor platforms. In all cases, there is a finite time window defined in terms of an ambient clock that frames the beginning and end of the time series ensemble.

In a simple exemplary embodiment, an image sensor consisting of a photosensitive pixel raster is furnished with a shutter that opens once and subsequently closes once, producing an ensemble of pixel data in a time series that may include sub-pixel data (e.g., red, green, and blue) organized by the pixel clock acting as the ambient clock. Of course, there are many types of sensors other than photosensitive ones, including microphones, magnetic sensors, inertial sensors, accelerometers, etc. Accordingly, the foregoing exemplary embodiment consisting of only light percepts should not be taken to be limiting in the context of automated witnessing of institutionally interesting events.

In another exemplary embodiment, a smart phone, in the current commercialized art typically furnished with an array of sensors of different types, embodies an integrated circuit functioning as a strap-down navigation platform of the machine electromechanical (MEMS) type prepared to output a time series ensemble derived from signals related to a plurality of degrees of freedom according to the device reference frame. In an embodiment with full inertial sensors, 9 axes, respectively three axes each of acceleration, gyroscopic, and magnetic data, are provided to a data processing unit, organized in accordance with an ambient clock, and typically derived from GPS.

The sensor platform filters and thresholds 346 identify events via heuristics. These act as heuristic based perceptrons. A non-exhaustive list of examples of potential ground truth events identified by heuristic perceptrons may include: a plurality of devices being physically present within a single geographic region; a plurality of devices each detect a sound above or below a predetermined threshold amplitude or frequency; a plurality of devices each detect a sound meeting a threshold similarity to a predetermined machine recognized category of audio (e.g., a bird chirping); a plurality of devices each detect an acceleration or deceleration above a predetermined threshold; a plurality of devices detect a physical transit between a first region and a second region; a plurality of devices each predict that a respective current transit path will end at a same third region; a plurality of devices each detect an atmospheric pressure within a predetermined range of values; a plurality of devices detect an ambient brightness within a predetermined range of values; or a plurality of devices are each connected to a given wireless communication network.

The sensor data cache 348 is employed to support an “always listening” embodiment where the system is enabled to include data collected prior to the identification of some ground truth event to further characterize an event reading. The sensor data cache 348 stores data collected by a sensor platform for a temporary period (e.g., a past 30 seconds).

The sensor platform data combiner 350 fuses data from multiple sensors. In some embodiments, the sensor platform makes use of multiple sensors of various styles and types. Output of a plurality of sensors and/or a plurality of independent sensor platforms that record data as a time series ensemble is organized according to an ambient clock. Often the time series for the plurality of sensors will be subject to data processing methods characterized in the art as sensor fusion.

Different types of sensors furnish a diversity of percepts, each according to its distinct engineered function. For example, a camera trained on a speaker's mouth feeds a perceptron, enabling the perceptron to derive formant codes that to one degree or another accord with lip dynamics, as a human lip reader might adjudge. At the same time, a microphone within auditioning distance feeds the perceptron, enabling the perceptron to derive formant codes from the concomitant auditory stream. Given these two heterogeneously derived sequences of formant codes and an ambient clock, a sensor fusion processing stage seeks to reconcile the formants from the two sensor sources into a fused sequence of formant codes that is more accurate than either constituent sequence by itself.

Various techniques for sensor fusion are known in the art. In certain situations, mathematical models of purely physical phenomena play a key role. A classic example is the case of gyroscopic drift in inertial navigation. Individual sensor outputs or recognized precepts are fused according to data processing according to a mathematical model derived from physics, or according to data science techniques such as statistical classification, neural nets, fuzzy logic, etc.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

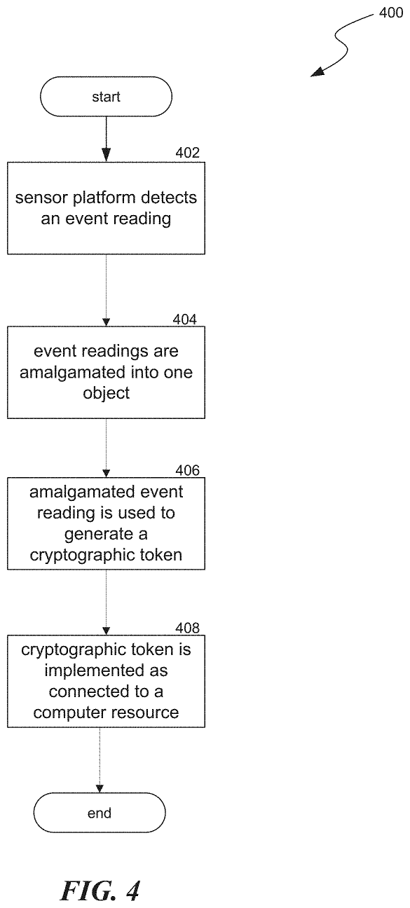

FIG. 4 is a flow diagram illustrating a process 400 used in some implementations for generation of cryptographic tokens via a single device. In some embodiments, the process of FIG. 4 is performed on a mobile device. Mobile devices include portable devices that are either worn or carried by a user, typically as part of daily life. The mobile device includes a sensor, or sensor platform, that collects data on the physical world around the device. In some embodiments, the sensor platform is initiated based on commands from a user (e.g., via an application GUI) and/or triggered by a detected event (e.g., predetermined sensor readings such as a predetermined time, a predetermined deceleration, or wireless communication with another predetermined device, or alternatively, machine recognition of a ground truth event such as the device being involved in a car crash, or that the user had met another person for coffee).

Previous reference has been made to the cryptographic token herein as being a purposeful, but distinctive, construct. Notably, some portions of or some steps involved in the creation of the cryptographic tokens may include some random, or pseudo-random element; however, in each case, the cryptographic token will have a relationship to non-random data that is connected to an observation of the real world.

In some implementations, process 400 can be performed “just in time,” for example, as a response to a user request. In some implementations, process 400 can be performed ahead of time, for example, on a schedule or when servers are determined to have available processing capacity.

In step 402, a sensor or sensor platform detects an event reading. The event reading is detected at a specificity that creates distinctive readings pertaining to a current physical circumstance of the sensor. For example, the sensor or sensor platform includes a camera, and the detection of the event reading includes taking a picture. That picture includes a set of pixels that portray a scene. In many cases, should a user reattempt to take the same picture, it is likely the camera would not be positioned in exactly the same orientation, or at the same height, or with other spatial factors, such that, at the very least, the pixels around the edges would vary from image to image.

The term “distinctive” is used rather than “unique” because, given a limited number of and/or low fidelity sensor elements, relatively mundane subject matter for an event reading, and a determined user, it is feasible that a given event reading may be recreated.

Additional examples may include taking a picture of something specific, such as a photograph of a string of numbers displayed on a nearby screen, or a photograph of a dollar bill. An attempt at re-creation of the photograph would be confounded based on having different numbers displayed, or a different dollar bill (with a different serial number) pictured.

Other examples make use of multiple sensors. For example, in addition to the camera as described above, the sensor platform may also employ a microphone. The event reading thus includes an audio track in addition to the image. The addition of an audio track increases the likelihood that a given event reading is distinctive. Sounds recorded while taking one picture are likely to vary if someone tried to retake the same picture. Audio QR codes can further add distinctiveness to a recording. Variance in audio is also driven by distance from source. If the microphone is in a user's pocket, the recording of a given sound will be different than when in open air. If the sound is emitted in an opposite direction as the microphone, the power of the sound will be lower. At a high enough fidelity, variations in the sensor platform's position relative to the sound increase distinctiveness.

The capture period depends on the sensors employed and is configurable based on any of user settings, contextual heuristics, random selection from a predetermined range, or application settings. In some embodiments, the capture period is instantaneous, or near-instant for the purposes of human perception. Where the sensor platform captures static readings, for example, an image, a temperature, a current speed, a current timestamp, or an air pressure, the capture period is “instant.” Where the sensor platform includes captured data such as audio, video, acceleration, tracked movement, or changes over time, the capture period is a function of time and may therefore have increased distinctiveness based on length of the capture period. Where a user begins and ends a given capture period, it is unlikely they will be able to suitably recreate the same length of capture period to millisecond (or greater) precision.

In some embodiments, the event readings are made distinctive by the inclusion of a distinctive physical object. While the distinctive physical object may be detected by numerous sensors, for ease of explanation, this disclosure will describe the use of optical or image data. An example distinctive physical object is a dollar bill. The dollar bill has a unique serial number (at least within the bill's respective print run). Another example of a distinctive physical object is a toy that has some recognizable variation in manufacture based on machining tolerances in the toy's respective production line. Even across multiple iterations of multiple users capturing optical data of the distinctive physical object, each user will have a different resulting cryptographic token that represents their distinctive physical object.

In some embodiments, the event readings are made distinctive by the inclusion of a found physical object. A found physical object is any object that is not necessarily distinctive from others of its kind but is distinctive from physical objects of other types. Based on the wide variation of physical objects in the world, the inclusion of a found physical object in the event readings will increase the distinctiveness of the resulting cryptographic token. Where the generation of the cryptographic token includes one-way functions (e.g., such as hash functions) a subsequent-comer will not have any hints toward what the found physical object was, or how the found physical object was positioned when included in the event readings. Examples of found physical objects are the racecar Monopoly® game piece, a Google Pixel 3a® smartphone including a protective case with a neon yellow button, a U.S. quarter minted in 1983, an empty bottle of Beringer® Cabernet Sauvignon from 1985, or a Magic: The Gathering® playing card of the character “Kari Zev” from the Kaladesh® expansion set. While duplicates of each of the above items exist, the chance that a subsequent-comer would choose any of these items and the orientations at which the item was captured in the event readings are near zero. Thus, the resultant cryptographic token cannot be functionally recreated by another user.

In step 404, the event readings are amalgamated into one object. Examples of amalgamation include concatenation of raw data, hashing the combination of all sensors, translating the sensor output into a uniform language (e.g., binary), or generating a representative vector. Notably, hashing the event readings may have significantly varied results based on small changes (e.g., pixels on the edge of an image being varied, capture period varying by 0.01 seconds, etc.).

In step 406, the amalgamated event reading is used to generate a cryptographic token. In some embodiments, the cryptographic token is the raw output of step 404. In other embodiments, creation of the cryptographic token includes one or more processing steps further. In some cases, the methods described in step 404 above may be implemented to generate the cryptographic token. As an illustrative example, the output of 404 may be hashed an additional time using a matching hash function to or newer hash function than that used in step 404.

In step 408, the cryptographic token is implemented as connected to a computer resource. The cryptographic token is used as part of a scheme to restrict access to a computer resource. The security scheme may vary. Examples include use as login information (e.g., all or part of a password), or use as device recognition (e.g., as an identifier for an authenticated device in a multi-factor authentication, “MFA” scheme).

In some embodiments, the computer resource is generated contemporaneously as the cryptographic token. Examples of a computer resource include a storage space that is in some way related to the moment in spacetime that has been captured by the sensor platform, or a communication channel to another user related to the moment in spacetime.

In other embodiments, the computer resource is generated asynchronously. For example, the computer resource is generated asynchronously where two users establish a computer resource together and one of said users did not have a relevant mobile application at the initial moment of data capture. Data capture may be performed at a time other than when the cryptographic token is generated.

Use case A: Where a user speaks a number into a phone connected to a call center (e.g., the last four digits of the user's social security number), the system initiates capture of those ordered digits together with the ephemeral noise and variable degradation of speech quality on the line to create a similar situation in the audio domain. In such a circumstance, a computer resource may be a recording of the phone call, and the recording is stored in a cloud database that is accessed and/or indexed via the cryptographic token.

Use case B: Not all implementations require a security context. Take, for example, a new class of collectibles for children makes use of cataloged nostalgia. Here, each toy together with the series of play engagements employing the toy, running in time from acquisition to discard, represents a kind of unique historical fingerprint of an aspect of the child's life (representable by a cryptographic token or series of cryptographic tokens) embedded in the household. In this case, a household database (computer resource) stores “nostalgia clips” of a child's life that are triggered via play with the distinctive toy. Each nostalgia clip is indexed to a respective cryptographic token.

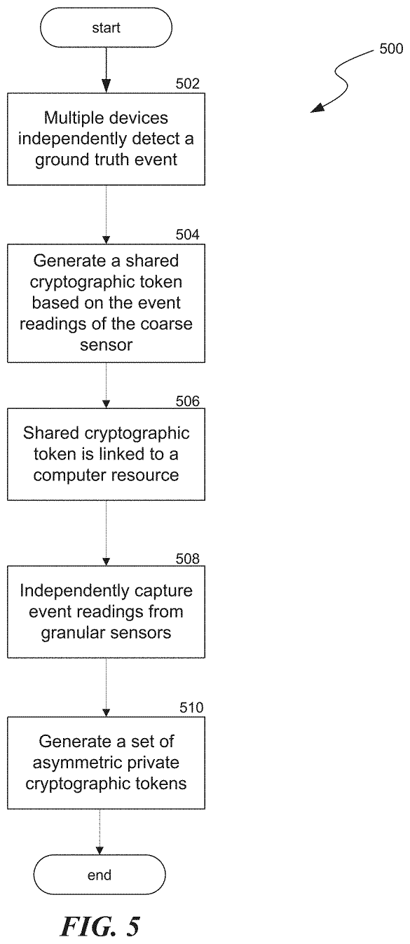

FIG. 5 is a flow diagram illustrating a process 500 used in some implementations for generation of cryptographic tokens coordinated across multiple devices. The process of FIG. 5 is similar to that of FIG. 4 but involves the collaboration of multiple devices. The process is instigated by an automatic detection of an accepted ground truth event that is similar across all devices involved; however, each device generates its own respective cryptographic token based on a difference in perspective of the ground truth event.

In step 502, multiple devices (e.g., sensor platforms, mobile devices, etc.) independently detect a ground truth event. Examples of a ground truth event include: being at a given address of location, being within near field communication (NFC) range of each other, being in involved in a car crash, having a matching type of object in a camera frame (e.g., a mobile phone). The ground truth event is detected with a coarse sensor. The term “coarse” is used in a relative sense—that is, the fidelity/precision of the coarse sensor is lower than the fidelity of a granular sensor (e.g., detection of presence at an address as opposed to detection of presence at GPS coordinates within 1 foot). The precision used by the coarse sensor is such that is it readily feasible that multiple devices may come to the same conclusion at the same time.

In step 504, the devices generate a shared cryptographic token based on the event readings of the coarse sensor. The generation of the shared cryptographic token may proceed according to any embodiment described herein implementing generation of cryptographic tokens. Because the respective coarse sensors have a relatively low level of precision, the event readings for each of the devices will match, and so will the shared cryptographic token.

In addition to other methods described herein, the shared cryptographic token may be independently generated by the system (e.g., not based on the coarse event reading). An independent creation scheme is possible because the token is shared. In such cases, the matching coarse event readings are used to match up the devices in a system backend and independently assign the users a shared token.

In step 506, the shared cryptographic token is linked to a computer resource as an identifier. The shared cryptographic token is used similarly to asymmetric keypairs in that one key identifies an asset publicly, whereas the other key is private and provides access to the asset (e.g., cryptocurrency keypairs). The shared cryptographic token is the public identifier of a given computer resource. Each of the participants in detecting the matching event reading from their respective coarse sensor will have private access to this computer resource via their own, distinctive, private cryptographic token (described in subsequent steps).

In step 508, the multiple devices independently capture event readings from granular sensors. The respective granular event readings are distinctive to each of the devices based on distinctive physical circumstances of each of the devices. For example, if the coarse sensor detects that the devices are present at a given address, the granular sensor may detect that the devices are at locations that are approximately 3 feet apart from one another. If the coarse sensor detects that a viewfinder of a camera of each device includes the other device in frame, the granular sensor detects any of: precisely where in the frame the other device is, what make/model the other device is, and/or what the other device is displaying on screen.

In some embodiments, the granular sensor and coarse sensor make use of the same sensor hardware. As described above, the granular reading and the coarse reading may be location data. Through application of filters/thresholds on the data recorded by any given sensor, the system can have both a coarse and a granular sensor. The capture of data occurs once for both “sensors,” but two sets of readings are generated after the application of filters/thresholds. Using the location data example, the data may be recorded at a fidelity suitable for the granular sensor, but the application of a filter identifies that a given pinpoint location is within a given address, and thus the system has an event reading that the device is at the address.

In some embodiments, the granular sensor and coarse sensor use different sensor hardware. For example, an NFC transceiver may identify that two devices are conducting a communications session (coarse event), whereas the respective cameras of the devices are capturing different images.

In step 510, the system generates a set of asymmetric private cryptographic tokens from the granular event readings. Each asymmetric private cryptographic token is linked to a user who operates the respective device. The generation of the asymmetric private cryptographic tokens may proceed according to any embodiment described herein implementing generation of cryptographic tokens. Because the respective granular sensors have a relatively high level of precision, the event readings for each of the devices will be distinctive, and so will each asymmetric private cryptographic token. The asymmetric private cryptographic token is implemented as a user identifier or as part or all of a security challenge answer for that user with respect to the computer resource.

The following script proposes what the registration phase of a new type of messaging app might look like. Prior to registration, Alice and Bob have met in a coffee shop. Bob wants to connect with Alice and Alice agrees while using the disclosed system. The system enables them to reach each other without sharing real phone numbers, emails, and in fact, without sharing any personally identifiable information.

Alice opens a mobile application and puts it into “new friend” mode, entering Bob's name as the new friend. The mobile application turns on the camera and begins to look for a dialer keypad on the display of a cell phone in its respective frame. Alice asks Bob to put his cell phone into dialing mode. He does so and it is now showing its native dialer. Alice points her phone's camera at Bob's phone. Once the mobile application succeeds in finding Bob's dialer, it indicates that it sees a phone (coarse event reading). The app inquires whether Alice wants to connect. Alice indicates, “Yes.” The mobile application directs Bob to enter any 10 digits, like dialing a random number. Bob puts in (444)555-1212. The number is showing in his dialer view, above the keypad.

The mobile application captures an image (granular event reading) of Bob's phone including (444)555-1212. Bob then does the same with Alice. Bob points his camera at Alice's phone with the dialer on the screen. Bob's phone announces that it sees a phone with a dialer (matching coarse event reading).

Alice's phone puts a random 10-digit number into its display and Bob's phone takes a picture (distinctive granular event reading). The mobile application announces, “You and your new friend are now connected through this mobile application. Be nice to each other, now!” In the backend, each copy of the mobile application has connected independently to the messaging backend, registered the pair of images of random 10-digit numbers (asymmetric private cryptographic tokens), and a token has been generated for the new friendship (shared cryptographic token), and more generally speaking, a memorialized pairing of two individuals that took place in physical proximity (alternate matching coarse event). This meeting token represents the root of a tree that further represents a multidimensional address space connected with the pairing.

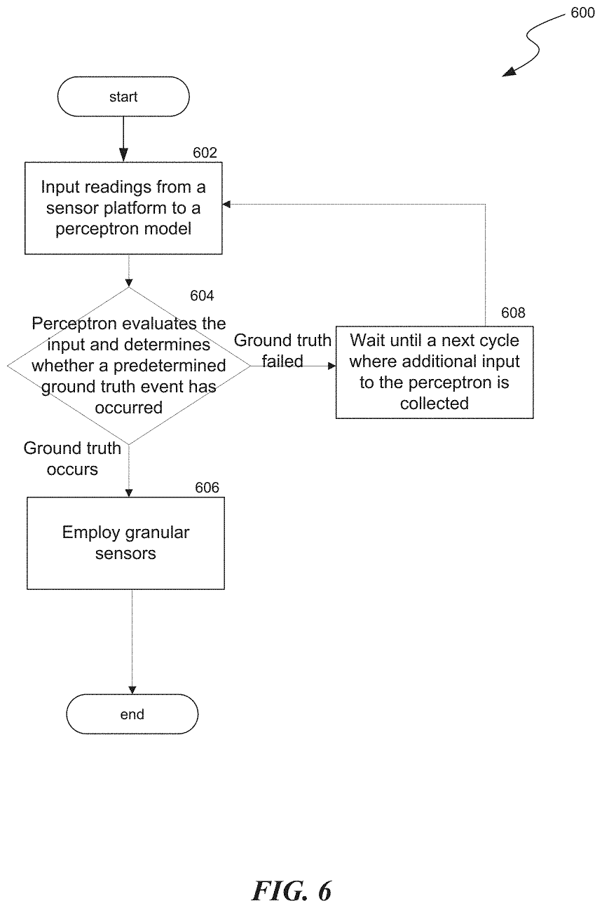

FIG. 6 is a flow diagram illustrating a process used in some implementations for machine recognition of events. A perceptron is a computer model or computing means running a computer model prepared to represent or simulate the ability of a human to recognize, distinguish, or classify. A percept in the case of a perceptron is the output of a recognition, distinguishing, or classification stage of the perceptron in response to an instance of data on which the perceptron has been prepared to act. In the typical case, the data in question is a numerical time series or ensemble of time series from a single sensor or a plurality of sensors, respectively. In the plural case, the ensemble of time series may be related to sensors affixed to a single sensor platform or, in an alternative case, to a plurality of sensor platforms. In all cases, there is a finite time window defined in terms of an ambient clock that frames the beginning and end of the time series ensemble.

In a simple exemplary embodiment, an image sensor consisting of a photosensitive pixel raster is furnished with a shutter that opens once and subsequently closes once, producing an ensemble of pixel data in a time series that may include sub-pixel data (red, green, blue, for example) organized by the pixel clock acting as the ambient clock. Of course, there are many types of sensors other than photosensitive ones, including microphones, magnetic sensors, inertial sensors, accelerometers, etc. Accordingly, the foregoing exemplary embodiment consisting of only light percepts should not be taken to be limiting in the context of automated witnessing of institutionally interesting events.

In step 602, readings from a sensor platform are input to a perceptron model (e.g., a trained machine learning model). In step 604, the perceptron evaluates the input and determines whether a predetermined ground truth event has occurred. In step 606, the ground truth event has occurred, and the granular sensors are employed.

In some embodiments, where sensors are in an “always listening” mode, employing the granular sensors involves collecting recorded data from a local cache (e.g., potentially the same data used by the perceptron in step 602 or even additional data captured before and/or after the perceptron input data).

In other embodiments, sensors are employed in series. That is, in response to the perceptron detecting the ground truth event, the granular sensors collect new data as the granular event reading.

Where the perceptron does not detect a ground truth event, in step 608, the system waits until a next cycle where additional input to the perceptron is collected.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a LAN, a WAN, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two other specified values, that an item under comparison is among a middle specified number of items, or that an item under comparison has a value within a middle specified percentage range. Relative terms, such as “high” or “unimportant,” when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word(s) “or” or “and/or” refers to any possible permutation of a set of items. For example, the phrase “A, B, or C” refers to at least one of A, B, C, or any combination thereof, such as any of: A; B; C; A and B; A and C; B and C; A, B, and C; or multiples of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A method of generating a cryptographic token comprising:
detecting an event reading via a sensor platform of a mobile device, wherein the event reading is detected at a specificity that creates distinctive readings pertaining to a current physical circumstance of the mobile device; and
generating the cryptographic token based on the event reading.

2. The method of claim 1, wherein the event reading is an amalgamation of readings by a plurality of sensors of the sensor platform.

3. The method of claim 2, wherein generating the cryptographic token further comprises:
hashing the amalgamation of readings.

4. The method of claim 1, further comprising:
linking the cryptographic token to an authentication procedure for a computer resource, wherein the computer resource is generated contemporaneously with the cryptographic token.

5. The method of claim 1, wherein the detecting is performed in response to:
identifying, via a machine learning model, input from the sensor platform as an occurrence of a first type of predetermined recognized event.

6. A method of generating asymmetric cryptographic tokens comprising:
detecting a first event reading via respective coarse sensors of each of a plurality of mobile devices, wherein the first event reading matches across each of the coarse sensors of the plurality of mobile devices;
generating a shared token based on the first event reading for each of the plurality of mobile devices;
detecting respective second event readings via respective granular sensors of each of the plurality of mobile devices, wherein the respective second event readings are distinctive to each of the plurality of mobile devices based on distinctive physical circumstances of each of the plurality of mobile devices; and
generating respective asymmetric tokens by each of the plurality of mobile devices based on the respective second event readings as distinctively detected by each of the plurality of mobile devices, where there is a cryptographic relationship between the respective asymmetric tokens of each of the plurality of mobile devices and the shared token.

7. The method of claim 6, wherein the shared token identifies a shared computer resource and each of the respective asymmetric tokens are used in login credentials to the shared computer resource that correspond to each of the plurality of mobile devices.

8. The method of claim 6, further comprising:
tracking changes made to the shared computer resource as logged to specific mobile device of the plurality of mobile devices.

9. The method of claim 6, wherein the respective coarse sensors detect events as being within predetermined ranges of values.

10. The method of claim 6, wherein the granular sensor is a camera.

11. The method of claim 6, wherein the granular sensor detects gyroscopic drift over a predetermined period of time.

12. The method of claim 6, wherein the first event reading is any of:
the plurality of devices are physically present within a single geographic region;
the plurality of devices detected a sound above or below a predetermined threshold amplitude or frequency;
the plurality of devices detected a sound meeting a threshold similarity to a predetermined audio clip;
the plurality of devices detected an acceleration or deceleration above a predetermined threshold;
the plurality of devices detected a physical transit between a first region and a second region;
the plurality of devices each predict that a respective current transit path will end at a same third region;
the plurality of devices detected an atmospheric pressure within a predetermined range of values;
the plurality of devices detected an ambient brightness within a predetermined range of values;
the plurality of devices are each connected to a given wireless communication network; or
any combination of detections above.

13. The method of claim 6, wherein the first event reading and the respective second event readings are detected contemporaneously.

14. The method of claim 6, wherein generating respective asymmetric tokens further comprises:
hashing the respective second event readings.

15. The method of claim 6, wherein the granular sensor includes a suite of sensors and the respective second event readings are an amalgamation of readings by the suite of sensors.

16. A system of generating asymmetric cryptographic tokens comprising:
a coarse sensor of a mobile device configured to detect a first event reading contemporaneously with other coarse sensors of other mobile devices, wherein the first event reading matches across each of the mobile device and the other mobile devices;
a granular sensor of the mobile device configured to detect a second event reading contemporaneously with other granular sensors of the other mobile devices, wherein respective second event readings of the mobile device and the other mobile devices are distinctive based on distinctive physical circumstances of each of the mobile device and the other mobile devices; and
a memory including processor implemented instructions that when executed cause the system to generate a shared token based on the first event reading associated with the mobile device and the other mobile devices, and further generate an asymmetric token associated with the mobile device and based on the second event reading as distinctively detected by the mobile device, where there is a cryptographic relationship between the asymmetric token and the shared token.

17. The system of claim 16, wherein the shared token identifies a shared computer resource and each of the asymmetric tokens are used in login credentials to the shared computer resource that are associated with the mobile device.

18. The system of claim 16, wherein the coarse sensor detects events as being within predetermined ranges of values.

19. The system of claim 16, wherein the granular sensor is a camera.

20. The system of claim 16, wherein the generation of the asymmetric token includes hashing the respective second event reading.

21. The system of claim 16, wherein the granular sensor includes a suite of sensors and the respective second event reading is an amalgamation of readings by the suite of sensors.
